(19) United States
(12) Patent Application Publication
(10) Pub. No.: US 2004/0140248 A1
(43) Pub. Date: Jul. 22, 2004

(54) Plastic flake processing

(76) Inventors: Matthew J. Dauzvardis, Manhattan, IL (US); Frank J. Schmidt, Lisle, IL (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/347,081

(22) Filed: Jan. 17, 2003

(51) Int. Cl. B07C 5/02

(52) U.S. Cl. 209/3.3

(57) ABSTRACT

A method for identifying and separating hydrophilic plastic from hydrophobic plastic includes tagging the hydrophilic plastic with a tagging agent, such as a fluorescent dye. Upon exposure to a water bath or other processing fluid, the hydrophilic plastic incorporates, such as by absorption, the tagging agent. The plastic containing the tagging agent is then detected and separated from the remainder of the plastic material.

### BACKGROUND

This invention relates to plastic processing, and more particularly to enabling identification and/or separation of impurities from a plastic stream.

In a conventional plastic recycling process, x-ray, optical, manual, and other means are used to sort plastic containers according to color, plastic type, and the like. After sorting, the containers typically are ground into plastic flake, which is then screened and washed in a caustic and alkaline bath that includes a surfactant. The plastic flake may also be subject to a pre-wash and post-wash rinsing or processing stage.

Multi-layer plastic products typically include structural layers of polyethylene terephthalate (“PET”) or other plastic such as polyethylene, polypropylene, polycarbonate, vinyl, acrylonitrile, copolymers, and the like. In addition, multi-layer plastic products often include an additional layer that enhances the performance of the main layers. For example, polyamide films are sometimes employed to diminish permeability of carbon dioxide or other gas from containers, films, and the like. U.S. Pat. Nos.5,055,355 and 5,547,765 discusses laminates of polyamides and ethylene vinyl alcohol copolymers (“EVOH”), and U.S. Pat. No. 6,280,679 discusses laminates of PET and EVOH, with respect to oxygen barrier properties.

Furthermore, U.S. Pat. Nos. 5,955,527; 5,639,815; 5,049,624; and/or 5,021,515, which are assigned to the assignee of the present invention, disclose an oxygen scavenging material that is suitable for use in containers, films, and the like. The oxygen scavenger may include an oxidizable organic component and a metal catalyst for the oxidation of the oxidizable organic component. The oxidizable organic component preferably is a polymer, such as a polyamide and especially MXD6, which is a condensation polymer of m-xylylenediamine and adipic acid. The metal catalyst may include cobalt, copper, rhodium compounds and/or other suitable substances.

It is generally desirable to separate polyamides, EVOH, and oxygen scavenger laminates or materials from structural layers or materials during the recycling process. For example, polyamides, EVOH, and oxygen scavenger materials are considered impurities in a stream of PET or the like. Conventional separation techniques, such as air elutriation or air separation, may be employed to separate such impurities from PET or the like.

Unfortunately, modem multi-layer products often are configured such that separation of the impurity laminates or materials is difficult. For example, the sidewall of a multi-layer container is often relatively thick in the finish area, and therefore impurity layers or materials are difficult to separate by conventional means. Further, barriers, scavengers, and the like are often employed in thin layers (that is, relative to the thickness of the structural layers) that tend to cling to the structural layers of PET or the like, and thereby hamper separation. Tie layers, if any, employed between functional and structural layers also may make separation more difficult.

Depending on the chemical properties of the particular impurity and the intended end-use of the particular structural polymer, a very small amount of impurity may render the recycling stream unacceptable for its intended use. Producing acceptable structural recycling streams will likely become more difficult as the barrier, scavenger, or other operative material usage increases relative to single layer products.

### SUMMARY

The present invention provides a method for identifying and thereby enabling separation of hydrophilic plastic from hydrophobic plastic. Plastic containers, films, and other plastic products often contain a mixture of hydrophilic plastic and hydrophobic plastic. The hydrophilic plastic is tagged by contacting the plastic flake with a fluid comprising a tagging agent. Tagging may include introducing the plastic flake into a caustic bath or water bath that includes a fluorescent dye or other tagging agent. The hydrophilic plastic incorporates, by (for example) absorption, a quantity of the agent while the hydrophobic plastic does not incorporate the tagging agent or incorporates a negligible amount of the tagging agent.

The material incorporating the tagging agent may then be detected and separated from the remaining plastic material. For example, the tagging agent may be a fluorescent dye, which may be illuminated by ultra-violet radiation. The illuminated material may be detected by conventional optical techniques. The detected material may be separated by conventional air separation techniques.

Additionally, a method is provided for preparing plastic flake for processing in which a hydrophilic plastic component, if any, of a quantity or stream of plastic is tagged with a tagging agent. For example, a fluorescent dye may be disposed in a caustic or water bath into which plastic flake is introduced. The hydrophilic material incorporates the tagging agent, which is then detectable and capable of being separated from other portions of the stream that have not incorporated the tagging agent.

The methods described herein may be employed to separate impurities, such as barrier, scavenger, or other functional materials, from a plastics recycling feed. The methods, however, is not limited to being employed with such impurities or in a recycling operation, but rather encompass being applied to remove or detect any substance from another substance in any context, including for example, removing or detecting such substance in raw plastic feedstock, post-recycling operations, and the like.

### BRIEF DESCRIPTION OF THE FIGURES

FIG. 1 is a block diagram indicating a process in which the present invention may be employed; and

FIG. 2 is a diagrammatic view of a portion of a plastic product on which the present invention may be employed.

### DETAILED DESCRIPTION OF PREFERRED EMBODIMENTS

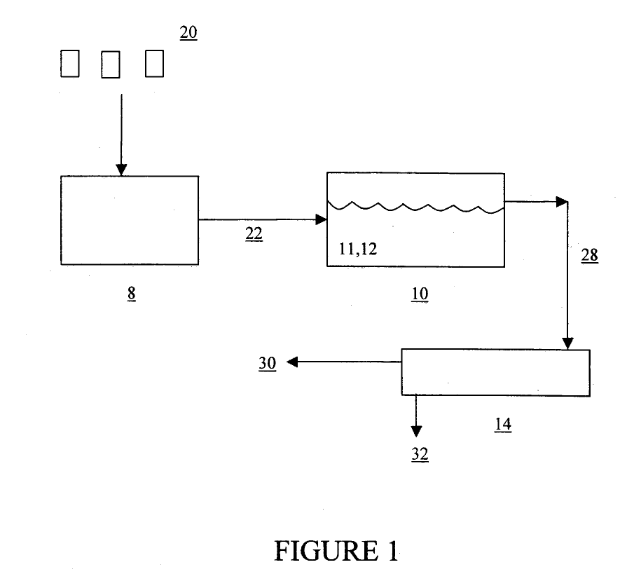

A process is provided for tagging hydrophilic plastics, if any, in a stream comprising hydrophobic plastic. Referring to FIG. 1 to illustrate the present invention in a plastic recycling context, plastic feedstock for a recycling process begins as bales 20 of post-consumer products or other products that have been designated for recycling. Typically, such products include plastic containers, films, and the like, which preferably have been sorted according to plastic type. The description of the process employs multi-layer bottles as an example of plastic feed 20 on which the present invention may be employed. Most types of multi-layer bottles have a sidewall thickness dimension in the finish area that is larger than the sidewall thickness in other portions of the bottle, and, thus, the finish area tends to resist separation by conventional techniques. Other portions of multi-layer bottles, such as the base, may also present separation difficulties.

Plastics 20 are ground in a conventional grinding process 8 to produce plastic flake 22. The equipment and techniques for grinding process 8 are well known in the plastics recycling and plastics processing industries, and will be understood by persons familiar with such industries and technology. The size and other physical characteristics of flake 22 may be chosen according to parameters relating to grinding process 8 and further processing steps (as discussed below), as will be understood by persons familiar with such processing steps in view of the present disclosure.

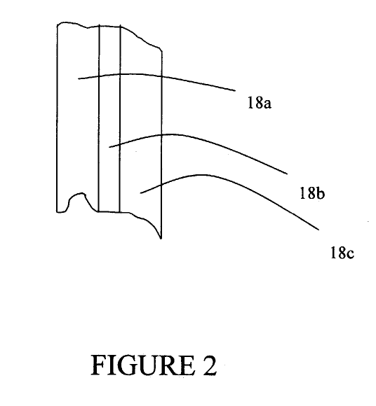

In this regard, FIG. 2 illustrates a portion of a multi-layer sidewall of a container, film, or the like. Outboard layers 18a and 18c are preferably structural layers of a first polymer, such as PET, polyethylene, polypropylene, polycarbonate, vinyl, acrylonitrile, and the like, and/or any combination of such materials. Inboard layer 18b preferably is a functional layer, such as that which comprises nylon or other hydrophilic material. Functional layer 18b may include an oxygen scavenger, an oxygen barrier, a carbon dioxide barrier, another barrier, a layer to enhance the appearance of the sidewall, a layer to enhance the temperature performance of the sidewall, or a layer to provide any other function. For example, functional layer 18b may include a polyamide with a metal catalyst, an EVOH, or nylon (that is, without catalyst), respectively, as described more fully above.

The compounds of layers 18a, 18b, and 18c are provided to illustrate materials that may be employed with the present invention, although the present invention is not limited to any particular compound. Rather, the present invention encompasses employing any compounds. According to an aspect of the present invention, at least one compound in the plastics stream 20 is hydrophilic. For example, polyamide and EVOH absorb water upon contact. Further, the present disclosure employs the terms “structural layer” and“functional layer” to illustrate a plastic quantity or feed stream 20. The present invention is not limited to employing material having such layers, but rather encompasses employing any materials, as described more fully herein.

Although FIG. 2 does not explicitly show a tie layer that may be employed between layer inboard layer 18b and outboard layers 18a and 18b, the present invention encompasses employing tie layers therebetween. Further, such tie layers may be subject to tagging and/or separation according to the process described herein.

After size reduction of plastics 20 in grinding process 8, layers 18a, 18b, and 18c may have a tendency to separate or de-laminate. Such de-lamination may promote separation of some the material of layer 18b from layers 18a and 18b. Conventional air elutriation or like conventional processes may be employed to accomplish of facilitate separation of such de-laminated material.

De-lamination of plastic flake 22 during grinding process 8 enhances incorporation of tagging agent 22 by hydrophilic plastic 18b by enhancing exposure of layer 18b to fluid 11. Similarly, tearing or puncturing of plastic flake 22 to form an irregular or jagged edge on flake 22 enhances such incorporation. Even for a portion of plastic flake in which layers 18a and 18c remain covering inboard layer 18b, an edge portion of inboard layer 18b may be exposed to enable fluid 11 to be absorbed to the extent that it is detectable, as explained more fully below.

After any (optional) air elutriation or other pre-separation stage and a (optional) conventional preliminary rinsing, plastic flake 22 is exposed to a fluid 11 that includes a tagging agent 12, such a fluorescent dye. Absorptive plastics, such as polyamide and EVOH, absorb fluid 11 and thus absorb the tagging agent. The present invention is not limited to being employed with plastics that absorb tagging agent 12, but rather encompasses any phenomena by which the hydrophilic plastic incorporates tagging agent 12, such as adsorption, adhesion, reaction to change a property or characteristic of the reactants, and the like.

The present invention also encompasses the incorporation of a relatively small amount of tagging agent 12 into the hydrophobic portion of flake 22. In this regard, a piece of hydrophobic plastic may incorporate tagging agent 12 to the extent that it is distinguishable from the hydrophilic plastic in the detection stage, which is described below. The term “not incorporating,” and variations thereof used herein, encompasses the negligible, insignificant, or distinguishable degree of incorporation by a hydrophobic material such that the hydrophobic plastic may be distinguishable from the hydrophilic material.

Tagging agent 12 may be any compound that marks the hydrophilic plastic, such as fluorescein. Preferably, fluorescein is employed as a concentration of less than 200 ppm, more preferably 2 ppm to 50 ppm, and even more preferably 10 ppm to 25 ppm. All magnitudes herein are approximate. Fluorescein in such concentrations is generally considered inexpensive and safe for food contact. The composition of tagging agent 12 may be chosen according to the particular target incorporation phenomenon and plastic material.

Preferably, flake 22 is exposed to fluid 11 in a bath 10. Fluid 11 may be a caustic, alkaline solution that includes not only tagging agent 12 but also a surfactant and other agents or properties to promote beneficial plastic characteristics, as will be familiar to persons familiar with such processes.

The plastic flake that exits bath 10 is indicated in FIG. 1 by reference numeral 28. The hydrophilic portion of plastic flake 28, upon incorporation of tagging agent 12, such as fluorescein, is detectable by illumination under certain lighting conditions, such as ultra-violet light. Upon detection, conventional air separation processes may be employed to remove the detected hydrophilic plastic. Such air separation processes include, for example, compressed air jets that are directed to the detected material on a moving belt. Such equipment and techniques are well known and may be supplied by a variety of commercial sources. For example, Satake/ESM International Inc. and others provide optical bulk sorters that may be employed.

The illumination, detection, and separation stage is indicated in FIG. 1 by reference numeral 14. A main stream 30 and an impurities stream 32 exit the separation process at stage 14. Main stream 30 encompasses any conventional plastic, such as PET or the like in the example of multi-layer containers. Impurities stream 32 includes plastic flake 28 that had been tagged by the dye and then detected and separated in stage 14.

The present invention also encompasses a method of preparing plastic flake for processing. The method includes providing a quantity of plastic flake that includes hydrophobic plastic and possibly some hydrophilic plastic. A tagging step, as described above, is employed to detect the presence of a minimum quantity or concentration of hydrophilic plastic. The method may be employed for quality control and quality assurance functions relating to impurities, such as the hydrophilic plastic material.

Some components are referred to herein, such as a grinding system, a bath, a detection means, and a separation means, which will be clearly understood by persons familiar with the particular, respective technology and/or plastics recycling or processing in general. Also, the term “dye” is employed herein to refer to any substance that changes the optical properties of the target material in a way that is detectable, including, for example, chromophores and flourophores.

The present invention is not limited to working on multi-layer plastic products, but rather encompasses any use that will be evident to persons familiar with plastics sorting or other processing in view of the present disclosure. For example, any embodiment of the present invention referred to herein may be employed to tag and/or separate incompatible hydrophilic plastic products from a hydrophobic plastics stream in any way. Further, the present invention encompasses the systems employed to carry out the methods described herein. The description refers to some individual process

We claim

1. A method of separating hydrophilic plastic from hydrophobic plastic, comprising the steps of:
a) providing plastic flake that includes hydrophilic plastic and hydrophobic plastic;
b) contacting the plastic flake with a fluid comprising a tagging agent, the hydrophilic plastic incorporating a quantity of the agent, the hydrophobic plastic not incorporating the agent;
c) illuminating the plastic flake;
d) detecting the illuminated hydrophilic plastic; and
e) separating the detected hydrophilic plastic from the hydrophobic plastic.

2. The method of claim 1 wherein the contacting step b) includes washing the plastic flake.

3. The method of claim 1 wherein the contacting step b) includes introducing the plastic flake into a water bath.

4. The method of claim 3 wherein the tagging agent is mixed into the water bath, and the hydrophilic plastic incorporating the tagging agent in the water bath.

5. The method of claim 4 wherein the hydrophilic plastic absorbs the tagging agent, thereby incorporating the tagging agent.

6. The method of claim 5 wherein the tagging agent becomes illuminated during the illuminating step c), whereby the tagging agent is detected during the detection step d).

7. The method of claim 6 wherein the tagging agent is a dye.

8. The method of claim 7 wherein the tagging agent is a fluorescent dye.

9. The method of claim 7 wherein the tagging agent is a fluorophore.

10. The method of claim 7 wherein the tagging agent is a chromophore.

11. The method of claim 7 wherein the tagging agent is fluorescein.

12. The method of claim 11 wherein the fluorescein is at a concentration of less than approximately 200 parts per million.

13. The method of claim 11 wherein the fluorescein is at a concentration of between 5 and 50 parts per million.

14. The method of claim 5 wherein the water bath is alkaline and at an elevated temperature.

15. The method of claim 5 wherein the hydrophobic plastic comprises at least one of a polyethylene terephthalate, a polyethylene, a polypropylene, a polycarbonate, an acrylonitrile, and a copolymers.

16. The method of claim 5 wherein the hydrophobic plastic is polyethylene terephthalate.

17. The method of claim 16 wherein the hydrophilic plastic is absorptive such that the hydrophilic plastic absorbs water and the tagging agent upon the contacting step b).

18. The method of claim 16 wherein the hydrophilic plastic comprises at least one of a nylon and an EVOH.

19. The method of claim 16 wherein the hydrophilic plastic comprises an oxygen scavenger.

20. The method of claim 16 wherein the hydrophilic plastic comprises an oxidizable organic component and a metal catalyst for the oxidation of the oxidizable organic component.

21. The method of claim 20 wherein the oxidizable organic component is a condensation polymer of m-xylylenediamine and adipic acid and metal catalyst includes one of cobalt, copper, and rhodium.

22. The method of claim 14 wherein the water bath includes a surfactant.

23. The method of claim 1 wherein the separating step e) includes separating the detected hydrophilic plastic by air means.

24. The method of claim 1 wherein the separating step e) includes separating the detected hydrophilic plastic by directing a jet of compressed air at said detected hydrophilic plastic.

25. The method of claim 1 wherein the providing step a) includes providing the ground plastic flake from plastic containers.

26. The method of claim 1 wherein the providing step a) includes grinding plastic containers.

27. The method of claim 26 wherein at least some of the plastic containers include polyethylene terephthalate and an oxygen scavenger.

28. The method of claim 26 wherein at least some of the plastic containers include polyethylene terephthalate and an oxygen barrier.

29. The method of claim 1 wherein the providing step a) includes grinding containers formed of both the hydrophilic plastic and the hydrophobic plastic.

30. The method of claim 29 wherein the containers include multiple layers.

31. The method of claim 1 wherein the illuminating step c) includes subjecting the flake to ultraviolet light.

32. The method of claim 1 further comprising the step of viewing the separated hydrophobic plastic to determine efficacy of the separation step.

33. The method of claim 32 wherein the viewing step includes illuminating the hydrophobic plastic.

34. A method for detecting and, if found, separating impurity plastics from a plastic stream, comprising the steps of:
a) providing ground plastic flake at least partially from plastics comprising multiple layers, at least one of the layers comprising a first material for oxygen protection and at least an other one of the layers comprising a second material;
b) contacting the plastic flake with a fluid comprising a tagging agent, the first material incorporating a quantity of the agent, the second material not incorporating the agent;
c) illuminating the plastic flake;
d) detecting the illuminated first material; and
e) separating the detected first material from the second material, whereby separating the first material removes impurities from the remaining plastic stream.

35. The method of claim 34 wherein the first material comprises an oxygen scavenger that takes up the fluid and thereby incorporates the tagging agent.

36. The method of claim 35 wherein the oxygen scavenger comprises an oxidizable organic component and a metal catalyst for the oxidation of the oxidizable organic component.

37. The method of claim 35 wherein second material comprises polyethylene terephthalate.

38. The method of claim 34 wherein the first material comprises an oxygen barrier that takes up the fluid, and thereby incorporates the tagging agent.

39. The method of claim 38 wherein the first material comprises EVOH.

40. The method of claim 38 wherein second material comprises polyethylene terephthalate.

41. The method of claim 34 wherein the contacting step b) includes washing the plastic flake.

42. The method of claim 34 wherein the contacting step b) includes introducing the plastic flake into a water bath.

43. The method of claim 34 wherein the illuminating step c) and the detecting step d) employ ultraviolet light.

44. The method of claim 34 wherein the tagging agent comprises a fluorescent dye.

45. The method of claim 34 wherein the tagging agent comprises fluorescein.

46. The method of claim 45 wherein the fluorescein is at a concentration of less than approximately 200 parts per million.

47. The method of claim 45 wherein the fluorescein is at a concentration of between 5 and 50 parts per million.

48. The method of claim 34 further comprising the step of viewing the separated hydrophobic plastic to determine efficacy of the separation step.

49. The method of claim 48 wherein the viewing step includes illuminating the hydrophobic plastic.

50. A method of preparing plastic flake for processing, comprising the steps of:
a) providing plastic flake that includes hydrophobic plastic and, possibly, hydrophilic plastic; and
b) tagging the hydrophilic plastic, if any, to enhance detection thereof by contacting the plastic flake with a fluid comprising a tagging agent, the hydrophilic plastic incorporating a detectable quantity of the tagging agent, the hydrophobic plastic not incorporating the agent;
whereby the tagging agent incorporated in the hydrophilic plastic is capable of being detected and thereby identified.

51. The method of claim 50 further comprising the step of detecting the hydrophilic plastic after said hydrophilic plastic incorporates the tagging agent.

52. The method of claim 51 wherein the detected plastic provides an indication of an amount of hydrophilic plastic in the plastic flake.

53. The method of claim 50 wherein the hydrophilic plastic comprises at least one of a barrier material and a scavenger material.

54. The method of claim 50 wherein the hydrophilic plastic comprises material for oxygen protection.

55. The method of claim 54 wherein the material for oxygen protection comprises an oxygen scavenger that takes up the fluid and thereby incorporates the tagging agent.

56. The method of claim 55 wherein the oxygen scavenger comprises an oxidizable organic component and a metal catalyst for the oxidation of the oxidizable organic component.

57. The method of claim 54 wherein the material for oxygen protection comprises an oxygen barrier that takes up the fluid and thereby incorporates the tagging agent.

58. The method of claim 57 wherein the oxygen barrier comprises EVOH.

59. The method of claim 54 wherein the hydrophobic plastic comprises polyethylene terephthalate.

60. The method of claim 54 wherein the tagging step b) includes washing the plastic flake.

61. The method of claim 54 wherein the tagging step b) includes introducing the plastic flake into a water bath.

62. The method of claim 61 wherein the tagging agent is disposed in the water bath.

63. The method of claim 54 wherein the tagging agent is a fluorescent dye.

64. The method of claim 54 wherein the tagging agent is fluorescein.

65. The method of claim 64 wherein the fluorescein is at a concentration of less than approximately 200 parts per million.

66. The method of claim 64 wherein the fluorescein is at a concentration of between 5 and 50 parts per million.

67. The method of claim 64 wherein the fluorescein is at a concentration of between 10 and 25 parts per million.

68. The method of claim 50 wherein said plastic flake contains a negligible amount of hydrophilic plastic such that said method is employed to verify purity of said plastic flake.

69. A system for detecting and separating impurity plastics from a plastic stream, comprising the steps of:
c) a grinding system for receiving and reducing size of plastic products to produce a plastic flake, the grinding system including metallic grinding elements;
d) a bath including a fluid for receiving the plastic flake, the fluid comprising a tagging agent that is capable of being incorporated into a hydrophilic component of the plastic flake; and
e) detection means for detecting said tagging agent incorporated into the hydrophilic component of the plastic flake; and
f) separation means for removing the detected hydrophilic component from a remainder of the plastic flake.
